(19) United States
(12) Patent Application Publication
(10) Pub. No.: US 2012/0226624 A1
(43) Pub. Date: Sep. 6, 2012

(54) OPTIMIZATION SYSTEM OF SMART LOGISTICS NETWORK

(76) Inventors: Byung Jun SONG, Gyeonggi-do (KR); Kang Hyeok Lee, Gyeonggi-do (KR); Seon Min Hwang, Gyeonggi-do (KR)

(21) Appl. No.: 13/053,072

(22) Filed: Mar. 21, 2011

(30) Foreign Application Priority Data
Mar. 4, 2011 (KR) 10-2011-0019603

(51) Int. Cl. G06Q 10/00

(52) U.S. Cl. 705/338

(57) ABSTRACT

The present invention relates to an optimization system of a smart logistics network capable of providing an optimal plan in terms of an architecture of a logistics network of a shipper, the number and capacity of logistics centers, a transport network, a router, etc., in order to be able to minimize distribution cost and CO₂ emission at the present time and over the medium and long term.

### CROSS-REFERENCE TO RELATED APPLICATIONS

This application claims priority to and the benefit of Korean Patent Application No. 10-2011-0019603 filed in the Korean Intellectual Property Office on Mar. 4, 2011, the entire contents of which are incorporated herein by reference.

### TECHNICAL FIELD

The present invention relates to an optimization system of a smart logistics network capable of allowing a shipper and logistics companies to synthetically analyze their own logistics system and design and operate an optimal logistics network. More particularly, the present invention relates to an optimization system of a smart logistics network capable of providing an optimal plan in terms of an architecture of a logistics network of a shipper, the number and capacity of logistics centers, a transport network, a router, etc., in order to be able to minimize distribution cost and CO₂ emission at the present time and over the medium and long term.

### BACKGROUND

Generally, a logistics center is a facility that stores produced products temporarily or over a long term and then, releases the produced products and rapidly distributes the released products to a consumption area, if necessary. The logistics center includes storage facilities for loading articles and delivery facilities for delivering stocked articles to a storage facility or picking articles stored in the storage facility to deliver the picked articles to a shipping area.

Alternatively, the logistics center may include a depalletizer depalletizing articles loaded on a pallet into an individual box unit or a sorter for sorting the delivered articles. In an automation logistics center automatically handling from stocking to the releasing of the articles, a management system controls stocking and the releasing state of the articles, the inventory of the articles, the position of the articles, etc., and a facility control system controls an operation of each facility.

When the logistics center issues a releasing instruction based on an order of customers, articles are automatically picked from the storage facility and are delivered to the releasing area. The articles delivered to the releasing area may be in a state loaded in a pallet or an individual box state.

Partners demand that the logistics companies follow the loading conditions, including storage conditions, transport situations, etc., of the partners, when releasing articles. That is, the partners demand that the logistics companies follow the size of the pallet, the loading height and the loading amount of the articles, etc. When the loading state of the releasing articles coincides with the demand of the partners, the articles may be delivered as they are.

However, since most do not correspond to the case, the logistics centers need to again load articles on the pallet according to the partners' desired loading conditions before releasing the articles, such that the releasing process is complicated and difficult, thereby causing temporal and economical loss.

Meanwhile, the integrated logistics system has been progressed a manner for each company to integrate some functions. Some door-to-door services are operated as a consignment agency in some areas but do not provide integrated services under consistent responsibility in a vendor to a federal group type.

In spite of pursuing logistics enhancement policies, demanding a third party logistics-oriented logistics specialization, and sharing an integrated logistics system, competitiveness of domestic logistics companies is weakened and customer service quality of logistics companies is degraded, due to a provision of logistics services for each sector by a plurality of service subjects.

That is, the logistics system is insufficient in terms of efficiency in a link and an operation among related subjects such as a government, an organization, a stronghold of logistics, etc., such that logistic costs are excessive. In order to solve these problems, a need exists for a method for efficiently improving a complicated logistics process and optimizing logistics.

The optimization technology according to the related art uses a solution to assist a value chain plan to perform a sale through inventory control optimization, inventory control, and an operation plan and another technology uses a meta-heuristic method to perform simulation for optimizing a logistics network in order to avoid computer restriction.

Further, there is a distance/time generating technology for each section using a GIS, but there is no optimization technology providing dynamic path generation to integrate and consider an entire consumer-based logistics network and a service using the same. Therefore, the related art only places emphasis on a plan and supports planning for an efficient operation of an existing logistics infrastructure.

Therefore, the present applicant has developed a knowledge-based logistics service for optimally decision-making a shipper-oriented smart logistics network capable of securing competitiveness of industry logistics and rapidly and actively coping with a dangerous situation such as logistics chaos by saving logistics costs and reducing CO₂ emission with the introduction of a low carbon green growth era.

### SUMMARY

The present inventors have developed a knowledge-based logistics service system. The present invention has been made in an effort to provide an optimization system for an efficient smart logistics network matching optimization and object function in consideration of a modal shift in order to establish a delivery plan satisfying an area of economic profit, environmental soundness, and social responsibility and perform an alternative transport means reducing CO₂ emission and common vehicle delivery for an inland transport.

An exemplary embodiment of the present invention provides an optimization system of a smart logistics network, including: scheduling a modal shift at a route optimization module to perform common vehicle delivery of an alternative transport means and an inland transport in order to reduce CO₂ emission with an order of an urgent or general delivery; and adjusting a schedule of path optimization by setting coordinate values and restriction conditions for each delivery state information of a monitoring module and an object function of minimum cost and minimum CO₂ emission and designing an optimization algorithm at the route optimization module, wherein the schedule adjustment is performed in the monitoring moduleI in an order of delivery plan transmission, real-time positioning, orbital information on delivery performance management, coordinate values, and a delivery information state.

Another exemplary embodiment of the present invention provides an optimization system of a smart logistics network, including: a route optimization module 10 and a shipper system, wherein the optimization system is logistics-networked with a logistics integrated database and a standard interface built and operated to generalize logistics related data by processing and analyzing the collected information according to a total logistics information network and a logistics current situation survey; the route optimization module performs customer generation processing through GEO coding and transport/delivery order generation processing during a transport/delivery order step, the transport/delivery order generated according to a shipping order at a shipper system optimizes a shipping plan in consideration of CO₂ emission according to setting an area for each customer, contract conditions, and object function during a vehicle delivery plan and releasing step, manually adjusts a vehicle delivery result, and instructs picking to a shipper system to move the picked products to a shipping point through picking work for each vehicle/product/location; and the optimization system includes a loading step during at an invoice issuance/loading step through a box/pallet invoice issuance step, a box/pallet attachment step, a packing working step for each customer, and the packing and releasing establishment step according to the picking instruction.

Yet another exemplary embodiment of the present invention provides an optimization system of a smart logistics network, including: a route optimization module and a shipper system, wherein the optimization system is logistics-networked with a logistics integrated database and a standard interface built and operated to generalize logistics related data by processing and analyzing the collected information according to a total logistics information network and a logistics current situation survey; the route optimization module generates and processes a transport/delivery order based on a shipping order of the shipper system during a transport/delivery order and generates and processes a customer through GEO coding, and determines whether an order is a multi modal order during a vehicle delivery plan and a releasing step on the basis of the transport/delivery order generation processing; during the determining step, if it is determined that the order is the multi modal order, designates order division/transport means and then, issues the transport/delivery order for each transport means, while if it is determined that the order is not the multi modal order, directly issues the transport/delivery order for each transport means; performs shipping plan optimization according to the transport/delivery order for each transport means and then, makes a vehicle delivery result to be adjusted manually, and the optimization step is performed in consideration of the area setting for each customer, the restriction condition setting and the target function setting, CO₂ emission for each truck/railroad/ship support, distance/shipping cost for each section, railroad/ship sailing, and distance information/traffic information for each GIS information section.

According to the exemplary embodiments of the present invention, it can promote the optimal design and operation of the eco-environmental logistics network in consideration of the optimization of the CO₂ emission by reflecting the modal shift into the transport means to establish the transport/delivery plan and can establish the stable logistics network plan at a quicker time and a low cost for improving the effectiveness and efficiency of the logistics network.

Further, according to the exemplary embodiments of the present invention, it can effectively improve the complicated logistics process while optimizing the CO₂ emission according to the modal shift and strengthen the competitiveness of logistics by establishing the logistics optimization plan.

### BRIEF DESCRIPTION OF THE DRAWINGS

FIG. 1 is a block diagram for explaining an optimization system of a smart logistics network according to an exemplary embodiment of the present invention;

FIG. 2 is a functional diagram for schematically showing the optimization system of a smart logistics network according to the exemplary embodiment of the present invention; and

FIGS. 3 and 4 are process diagrams for explaining the optimization system of a smart logistics network according to the exemplary embodiment of the present invention.

### DETAILED DESCRIPTION

Hereinafter, exemplary embodiments of the present invention will be described in detail with reference to the accompanying drawings.

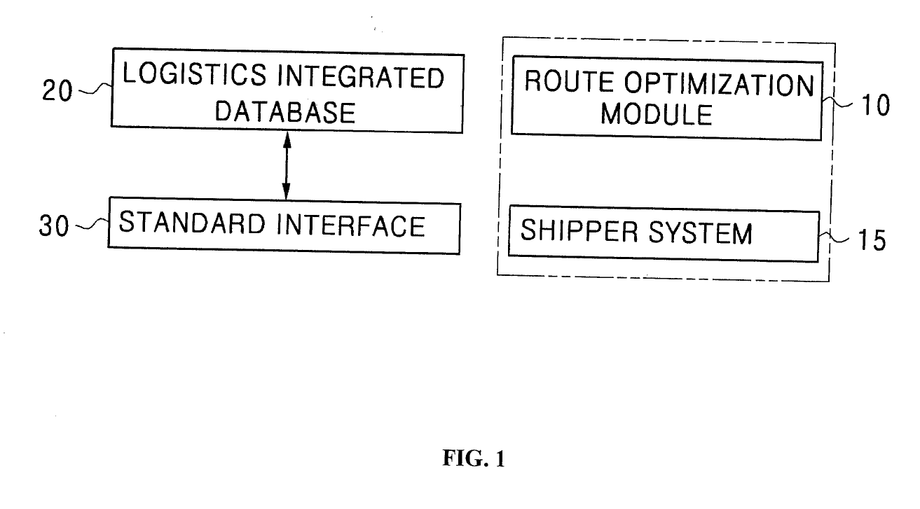

FIG. 1 is a block diagram for explaining an optimization system of a smart logistics network according to an exemplary embodiment of the present invention. The present invention relates to a smart logistics network system capable of allowing a shipper and logistics companies to synthetically analyze their own logistics system and design and operate an optimal logistics network, and more particularly, to an optimization system of a smart logistics network capable of providing an optimal plan in terms of an architecture of a logistics network of a shipper, the number and capacity of logistics centers, a transport network, a router, etc., in order to be able to minimize distribution cost and CO₂ emission at the present time and over the medium and long term.

The shipper-oriented logistics network service reflects a transport network situation of a geographic information system (GIS)/intelligent transportation system (ITS), and for example, is transported to a logistics center through an overland transport, such as a truck or a railroad, etc., from a marine and air terminal. In this case, the optimization system of the exemplary embodiment of the present invention is used in a logistics specialized company, a logistics consulting company, a business logistics charger, and a door-to-door company, a shopping mall, etc.

That is, the optimization system according to the exemplary embodiment of the present invention configured to include a route optimization module 10 and a shipper system 15 in a server is logistics-networked with a logistics integrated database 20 and a standard interface 30 built and operated so as to generalize logistics-related data by processing and analyzing the collected information according to a total logistics information network and a logistics current situation survey. In the shipper system 15, a company-wide resource management, a transport management system, and a warehouse management system, etc. may be networked.

The standard interface 30 may provide a knowledge-based service for optimally decision-making a shipper-oriented smart logistics network by interconnecting a reference information system, an order management system, a warehouse management system, and a transport management system, etc., with the optimization system according to the exemplary embodiment of the present invention through the logistics integrated database 20.

The functional structure of the optimization process is sorted into a C&C center and CO₂ emission for each sector and the basic information is sorted into a shipper, a transport company, a center, a product group, a product, a customer, a vehicle type, a vehicle, and a driver, etc.

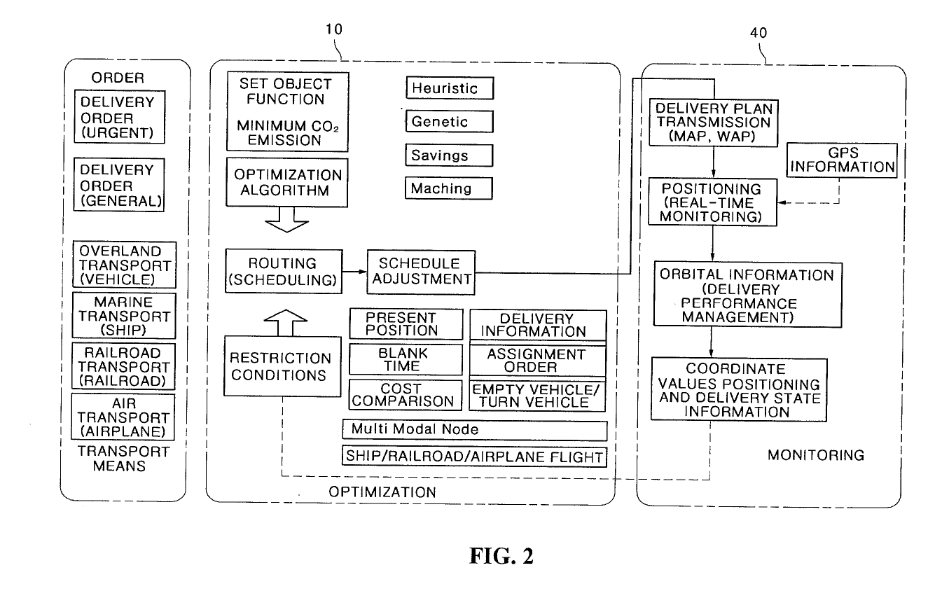

FIG. 2 is a functional diagram for schematically showing the optimization system of a smart logistics network according to the present invention. The transport means is sorted into overland transport (vehicle), marine transport (ship), railroad transport (railroad), and air transport (airplane), etc., and an order is sorted into an urgent delivery order and a general delivery order.

The order is routed (scheduled) in the optimization module 10 according to the exemplary embodiment of the present invention and is scheduled through the optimization algorithm by setting the object function of the minimum CO₂ emission at low cost and is scheduled according to coordinate values and delivery state information as restriction conditions in a monitoring module 40. The algorithm may use heuristic, genetic, savings, matching, etc.

As the schedule adjustment of the path optimization according to the scheduling of the optimization module 10, a current position, delivery information, blank time, assignment order, cost comparison, an empty vehicle/turn vehicle, a multi modal node, and a ship/railroad/airplane flight, etc., are considered. Therefore, the path optimization is searched based on order path division, object function, and restriction conditions in consideration of modal shift.

As described above, the schedule adjustment is configured of an order of delivery plan transmission (MAP, WAP), positioning (real-time monitoring), orbital information (delivery performance management), and coordinate values and delivery state information in the monitoring module 40. The positioning is added with the GPS information.

Therefore, the exemplary embodiment of the present invention can provide an optimization system for an efficient smart logistics network matching optimization and object function in consideration of a modal shift in order to establish a delivery plan satisfying an area of economic profit, environmental soundness, and social responsibility and perform common vehicle delivery for an alternative transport means and an inland transport capable of reducing CO₂ emission.

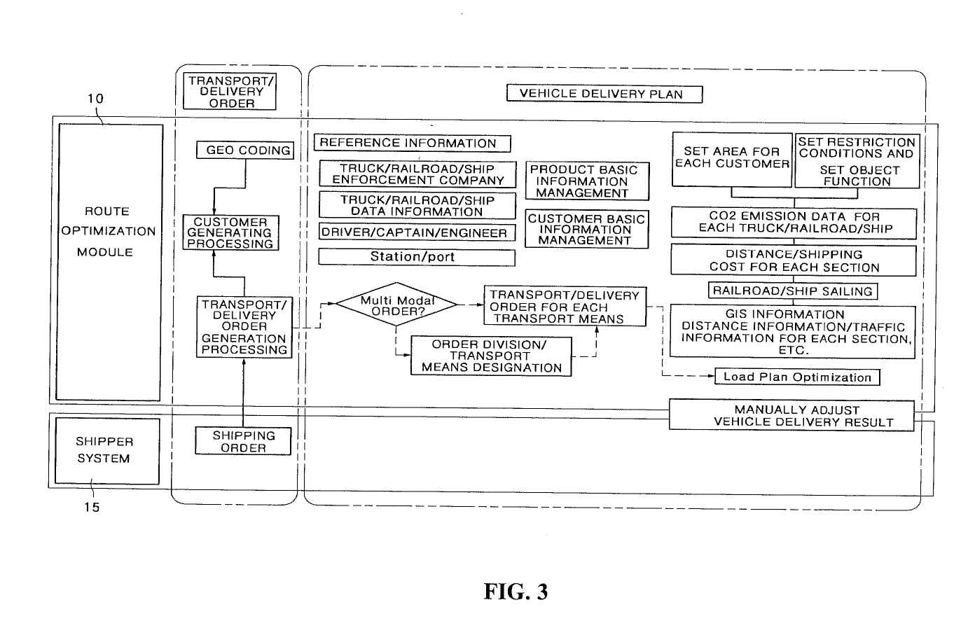

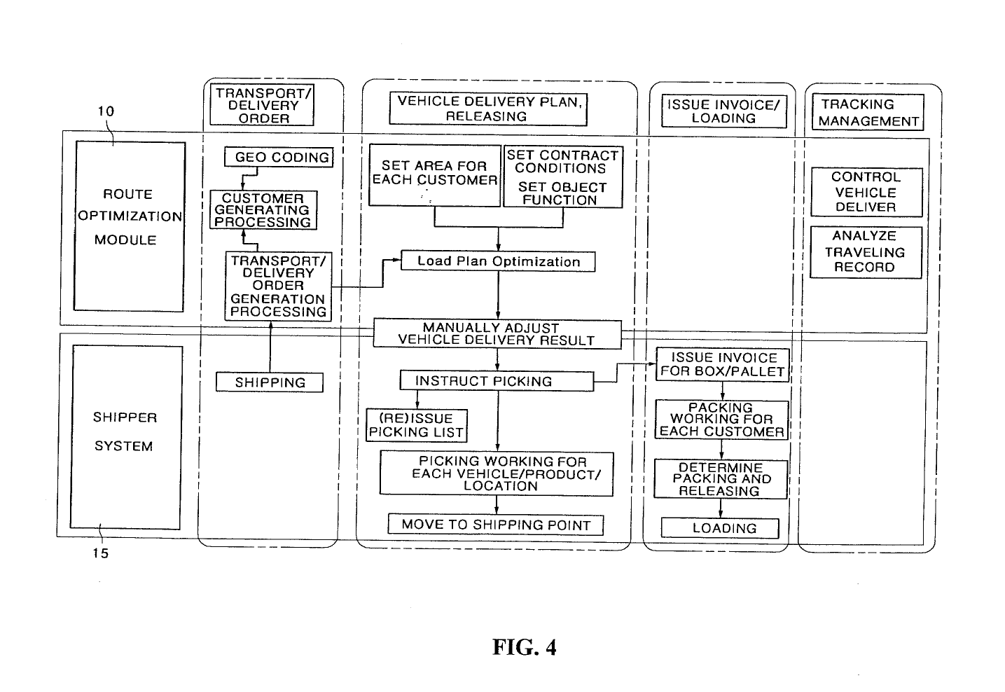

FIGS. 3 and 4 are process diagrams for explaining the optimization system of a smart logistics network according to the exemplary embodiment of the present invention. According to the exemplary embodiment of the present invention, the more efficient delivery schedule is planned through the previous simulation by designing and developing the process and the optimization algorithm and there are advantages in that the reduction in costs of the shipper, the rapid movement of logistics, the energy reduction, and the low carbon green growth may be achieved.

The optimization process shown in FIG. 3 is divided into a transport/delivery order step, a vehicle delivery plan and releasing step, an invoice issuance/loading step, and a tracking management step. When receiving a shipping order at a shipper system during the transport/delivery order step, the transport/delivery order is generated and processed at the route optimization module, while a customer is generated and processed based on GEO coding, and the area for each customer is set and the contract conditions and the object function are set during the vehicle delivery plan and the releasing step according to the transport/delivery order, thereby optimizing the shipping plan.

Thereafter, after making the vehicle delivery be manually adjusted, the optimization process instructs the shipper system to perform the picking working for each vehicle/product/location and moves the picked freights to a shipping point.

Meanwhile, after the picking instruction step, the invoice for attaching a box/pallet is issued and after the packing working for each customer is performed, the loading and unloading performs the invoice issuance and loading step are performed when the packing and releasing are determined.

The tracking management step analyzing the vehicle delivery control and the traveling record is performed during the transport.

The optimization process shown in FIG. 4 is divided into a transport/delivery order step and a vehicle delivery plan step in the route optimization module and the shipper system. During the vehicle delivery plan step, truck/railroad/ship enforcement company, product basic information management, truck/railroad/ship data information, customer basic information management, truck/railroad/ship master, driver/captain/engineer, and station/port are used as the reference information.

As described above, at the route optimization module, the transport/delivery order is generated and processed by receiving a shipping order at the shipper system during the transport/deliver order step, while the customer is generated and processed based on the GEO coding.

When the vehicle delivery plan is established at the route optimization module 10 based on the generated and processed transport/delivery order, the optimization module determines whether the transport/delivery order is a multi modal order.

If the transport/delivery order is not a multi modal order, the transport/delivery order for each transport means is issued. On the other hand, if the transport/delivery order is a multi modal order, the order division/transport means are designated and then, the transport/delivery order for each transport means is issued.

The transport/delivery order for each transport means issued as described above establishes the vehicle delivery plan through the shipping plan optimization and then, may adjust the manual for the vehicle delivery plan. In this case, the optimization step of the vehicle delivery plan is performed in consideration of CO₂ emission for each truck/railroad/ship support, distance/shipping cost for each section, railroad/ship sailing, distance information/traffic information for each GIS information section, etc., through the area setting step, the restriction condition setting and the target function setting step for each customer.

As set forth above, the exemplary embodiment of the present invention can promote the optimal design and operation of the eco-environmental logistics network in consideration of the optimization of the CO₂ emission by reflecting the modal shift into the transport means to establish the transport/delivery plan and can establish the stable logistics network plan at a quicker time and a low cost for improving the effectiveness and efficiency of the logistics network.

Further, the exemplary embodiment of the present invention can effectively improve the complicated logistics process while optimizing the CO₂ emission according to the modal shift and strengthen the competitiveness of logistics by establishing the logistics optimization plan.

The optimization system of the smart logistics network according to the exemplary embodiment of the present invention is not limited to the described exemplary embodiment. It is apparent to a person skilled in the art to which the present invention pertains that the exemplary embodiment of the present invention may be variously modified and changed.

Therefore, it is apparent that the modifications or changes belong to the appended claims of the present invention.

What is claimed is:

1. An optimization system of a smart logistics network, comprising:
scheduling a modal shift at a route optimization module to perform common vehicle delivery of an alternative transport means and an inland transport in order to reduce 00₂ emission with an order of an urgent or general delivery; and
adjusting a schedule of path optimization by setting coordinate values and restriction conditions for each delivery state information of a monitoring module and an object function of minimum cost and minimum CO₂ emission and designing an optimization algorithm at the route optimization module,
wherein the schedule adjustment is performed in the monitoring module in an order of delivery plan transmission, real-time positioning, orbital information on delivery performance management, coordinate values, and a delivery information state.

2. The optimization system of a smart logistics network of claim 1, wherein the algorithm is one of heuristic, genetic, savings, and matching methods.

3. The optimization system of a smart logistics network of claim 1, wherein the path optimization is order path division in consideration of the modal shift and a search based on an object function and restriction conditions.

4. An optimization system of a smart logistics network, comprising: a route optimization module and a shipper system, wherein the optimization system is logistics-networked with a logistics integrated database and a standard interface built and operated to generalize logistics related data by processing and analyzing the collected information according to a total logistics information network and a logistics current situation survey; the route optimization module performs customer generation processing through GEO coding and transport/delivery order generation processing during a transport/delivery order step, the transport/delivery order generated according to a shipping order at a shipper system optimizes a shipping plan in consideration of CO₂ emission according to setting an area for each customer, contract conditions, and object function during a vehicle delivery plan and releasing step, manually adjusts a vehicle delivery result, and instructs picking to a shipper system to move the picked products to a shipping point through picking work for each vehicle/product/location; and the optimization system includes a loading step during at an invoice issuance/loading step through a box/pallet invoice issuance step, a box/pallet attachment step, a packing working step for each customer, and the packing and releasing establishment step according to the picking instruction.

5. An optimization system of a smart logistics network, comprising: a route optimization module and a shipper system, wherein the optimization system is logistics-networked with a logistics integrated database and a standard interface built and operated to generalize logistics related data by processing and analyzing the collected information according to a total logistics information network and a logistics current situation survey; the route optimization module generates and processes a transport/delivery order based on a shipping order of the shipper system during a transport/delivery order and generates and processes a customer through GEO coding, and determines whether an order is a multi modal order during a vehicle delivery plan and a releasing step on the basis of the transport/delivery order generation processing; during the determining step, if it is determined that the order is the multi modal order, designates order division/transport means and then, issues the transport/delivery order for each transport means, while if it is determined that the order is not the multi modal order, directly issues the transport/delivery order for each transport means; performs shipping plan optimization according to the transport/delivery order for each transport means and then, makes a vehicle delivery result to be adjusted manually, and the optimization step is performed in consideration of the area setting for each customer, the restriction condition setting and the target function setting, CO₂ emission for each truck/railroad/ship support, distance/shipping cost for each section, railroad/ship sailing, and distance information/traffic information for each GIS information section.

6. The optimization system of a smart logistics network of claim 5, wherein during the vehicle delivery plan step, the reference information is truck/railroad/ship enforcement company, product basic information management, truck/railroad/ship data information, customer basic information management, truck/railroad/ship master, driver/captain/engineer, and station/port.
